(19) United States
(12) Patent Application Publication
(10) Pub. No.: US 2015/0047484 A1
(43) Pub. Date: Feb. 19, 2015

(54) SAW CUTTING GUIDE

(71) Applicant: Richard P. Lane, Waco, TX (US)

(72) Inventor: Richard P. Lane, Waco, TX (US)

(21) Appl. No.: 13/969,163

(22) Filed: Aug. 16, 2013

(51) Int. Cl. B23D 59/00; B23D 47/02; B23D 45/00

(52) U.S. Cl. CPC B23D 59/003; B23D 45/006; B23D 47/02
USPC 83/56; 83/829; 83/522.11

(57) ABSTRACT

The improved saw cutting guide of the present invention overcomes many of the disadvantages of prior art power cutting tools by providing a portable, mechanical guide for safely and accurately guiding a powered cutting tool along a predetermined cut line in the workpiece that is at a desired angular position relative to the cutting blade of the power cutting tool. The saw cutting guide includes a main baseplate having a top side and an under side, and featuring a guide track on the top side, for receiving and guiding a power cutting tool, and a pivotally mounted alignment fence on the underside for selectively aligning the work piece in relation to the guide track. In a preferred embodiment, the power cutting tool comprises an electric circular saw having a metal cutting blade featuring cold saw metal-cutting technology.

### BACKGROUND OF THE INVENTION

1. Technical Field of the Invention

This invention generally relates to power tools and, more particularly, to an apparatus and method for guiding a powered hand tool, such as a circular power saw, router, reciprocating sabre saw, or the like, along a predetermined line to be cut in a workpiece. More specifically, the present invention is directed at a portable saw guide that mechanically guides a metal-cutting circular power saw along a predetermined line to be cut in a metal workpiece at a desired angular position relative to the saw blade of the circular power saw.

2. Description of the Related Art

The construction of metal framed buildings often requires cutting mitered cuts in metal building materials. For example, rafter beams need to be cut accurately at a predetermined miter cut or pitch angle prior to being welded to a ridge beam. However, cutting metal beams accurately is typically a slow and time consuming process, especially at a remote worksite. Current conventional cutting methods typically rely upon oxy-acetylene or plasma cutting torches to free hand the cut along a marked cutting line. However, even for highly skilled craftsmen, such cuts must typically be finished with a grinder to remove any burrs resulting during the cutting prior to welding. Such cutting operations are further complicated by the wide variety of complex cross-sectional shapes that metal building materials commonly possess based upon building requirements. For example, steel beams and rafters typically comprise I- H- or T-beams, tubular (square, rectangular or cylindrical) beams or solid beams to name just a few.

A recent and promising development in metal cutting techniques has been the introduction of metal-cutting circular saws commonly known as cold saws. A cold saw is a sawing machine that utilizes a specially designed circular saw blade that cuts metal. The name “cold saw” is derived from the cutting process that is employed. During the cutting process, the metal is released in a shearing action by the saw teeth as the blade rotates. All of the energy and heat generated during the cutting process is transferred to the chips created by the cutting process. This enables the blade and the material being cut to remain cold. In contrast, an abrasive saw abrades the metal and creates a great deal of heat in the metal and the cutting blade. Such a metal-cutting circular cold saw enables an operator to cut through metal almost as easily and smoothly as a common circular saw cuts through lumber.

While portable electric metal-cutting circular saws are convenient, because of their light weight, they can also be difficult to use and control. Their very portability makes it difficult to obtain an accurately positioned, precision straight line crosscut. Oftentimes years of experience are required before a worker can quickly make accurate crosscuts on a continuous basis using a portable metal-cutting circular saw. However, using highly experienced workers to operate a metal-cutting circular saw adds substantially to construction costs. Frequently, less experienced workers are used resulting in the need to grind the cut end until suitably straight and flat for welding. Portable metal-cutting circular saws are also prone to experience a kickback or violent jerking motion if a saw cut is not maintained perfectly aligned. This is further compounded with cross-cutting the wide variety of complex cross-sectional shapes that metal building materials commonly possess based upon building requirements.

A variety of proposals have previously been made to address these issues. For example, numerous designs for metal cutting cut-off saws (a.k.a. chop saws) have previously been disclosed (see e.g., U.S. Pat. Nos. 6,478,664 and 6,609,442). Similar to wood-cutting miter saws, which are common in wood construction projects, metal-cutting chop saws have been used by construction contractors to establish a fixed, metal cutting center for use at a construction project. Whereas, previous chop saws typically used an abrasive wheel to cut metal, new embodiments are appearing which feature the same cold saw metal-cutting technology.

While utilizing such a metal-cutting chop saw facilitates good quality cross cuts with less experienced labor, there are increased material handling costs. When delivered, the metal workpieces (i.e., beams or girders) must be unloaded and stacked near the sawing center. Each workpiece must then be moved to a position next to a saw, positioned on the saw, cut and stacked. Each workpiece must then be moved again to a location at which it is to be finally used. Invariably some of the metal beams are sawed to an incorrect length or pitch angle, or routed to a wrong final assembly location. This not only necessitates additional handling but may idle skilled workers and slow construction while correct replacement materials are obtained. Moreover, the sheer weight of the metal workpieces further complicates the process, typically making such an operation, particularly in a remote location, impracticable.

Thus, a pressing need exists for an accurate, light weight, saw guide for a metal-cutting portable saw that would enable an inexperienced user to safely make fast but accurate crosscuts in metal building materials. Such a saw could be advantageously used as either a primary sawing tool or as a custom fitting supplement to a fixed position sawing center.

### SUMMARY OF THE INVENTION

The present invention overcomes many of the disadvantages of prior art powered cutting tools by providing a portable, mechanical guide for safely and accurately guiding the powered cutting tool along a predetermined cut line in the workpiece that is at a desired angular position relative to the saw blade of the power cutting tool. In a preferred embodiment, the powered cutting tool comprises a metal-cutting power tool.

The improved system includes a main base plate having a top side and an underside, a guide track configured on the top side, for receiving and guiding a powered cutting tool, and an alignment fence pivotally mounted to the underside for selectively aligning the work piece in relation to the guide track. In a preferred embodiment, the powered cutting tool comprises an electric circular saw having a metal cutting blade featuring cold saw metal-cutting technology.

The guide track includes two parallel guide rails for slidably capturing the lateral edges or sides of the guide plate or shoe (also known as plate, platform, sole, foot) of the powered cutting tool. The bottom surface of the guide plate rides on a supporting surface of the guide track. The supporting surface may further include friction-reducing devices and mechanisms to reduce the friction between the sliding guide plate and the guide track. In a preferred embodiment, the supporting surface is simply a planar extension of the main base plate surface. The supporting surface further includes formed therein a slot, which allows the cutting edge of the powered cutting tool to protrude through the supporting surface to cut the workpiece positioned below. The guide slot may be dimensioned so that the cutting edge of the powered cutting tool may be tilted so that it protrudes through the supporting surface at an acute or obtuse angle, thereby allowing the cutting of compound angles in the work piece. The guide track may also include at least one stop rail positioned between the parallel guide rails to limit the forward travel of the powered cutting tool.

The alignment fence is pivotally mounted to the underside of the device. The alignment fence includes a horizontal face, which interfaces with the underside of the main base plate, and a vertical face, which extends away from horizontal face and the underside of the main base plate. The alignment fence includes one end, which is pivotally attached to the underside of the device, and a distal end, which may be selectively positioned to align the workpiece in relation to the guide track. The distal end may further include a locking mechanism for selectively securing or fixing the position of the alignment fence relative to the main base plate. For example, in a preferred embodiment the main base plate further includes an arcuate slot formed therein, which allows a bolt connected near to the distal end of the alignment fence to extend from the underside to the top side of the main base plate. A washer and threaded wing knob is used to selectively secure the horizontal face of the alignment fence to the main base plate. The alignment fence may also include clamps for selectively holding the workpiece securely against the vertical face of the alignment fence.

The top side of the main base plate may further include indicia, which accurately indicate the angular position of the alignment fence relative to the guide track of the apparatus. For example, in one embodiment the main base plate may include angular indicia denoted in pitch angles or standard arc degree increments.

In another embodiment, the system of the present invention may further include a sliding guide plate permanently configured within the guide track. The sliding guide plate includes a mechanism for connecting to or interfacing with the guide plate or shoe of the powered cutting tool. Thus, a variety powered cutting tools may be adapted to the same saw cutting guide. The sliding guide plate may further include friction-reducing devices to reduce the friction between the sliding guide plate and the guide tack.

As will be demonstrated, the portable cutting guide of the present invention can be configured for either right-handed or left-handed saws and/or operators.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1A is a perspective view of an embodiment of the Saw Cutting Guide device of the present invention;

FIG. 1B is a bottom plan view thereof;

FIG. 2 is a reverse perspective view thereof;

FIG. 3 is an exploded perspective view thereof;

FIG. 4 is a bottom perspective view thereof;

FIG. 5 is a close-up view of a powered cutting saw engaged in the guide track in an embodiment of the Saw Cutting Guide device of the present invention;

FIG. 6 is a close-up top plan view of an alternate embodiment of the main base plate showing reference marks denoted in standard arc degrees; and

FIG. 7 is a perspective view of an alternate embodiment of the Saw Cutting Guide device of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

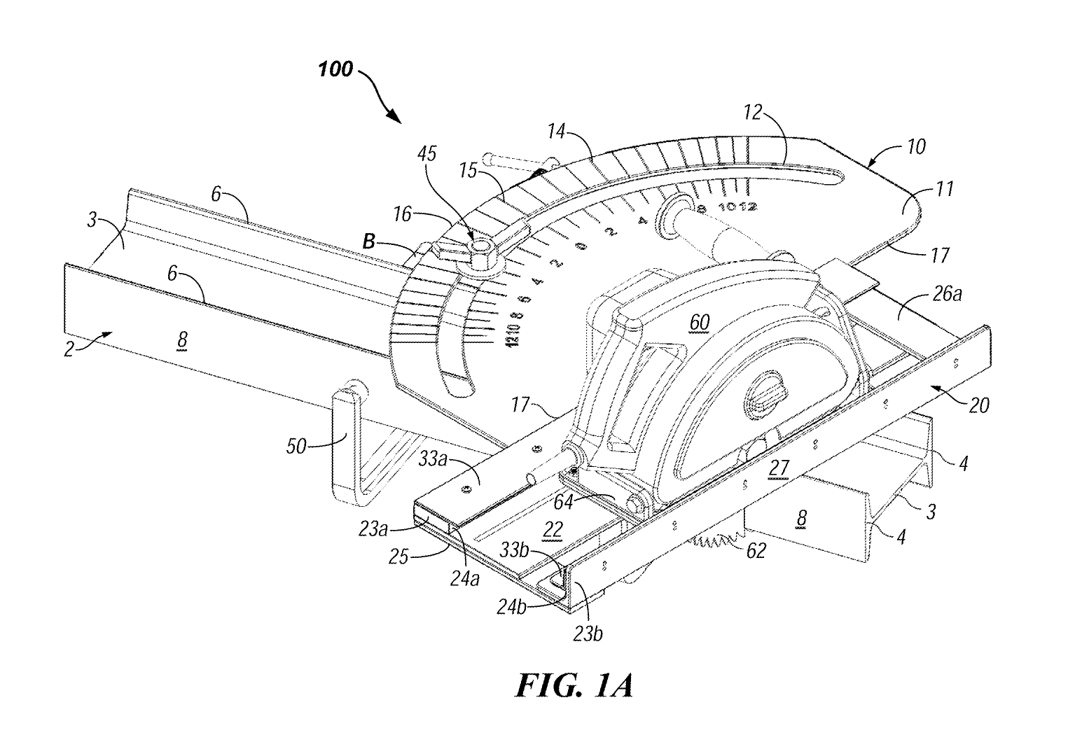

With reference to the Figures, and in particular FIGS. 1A and 1B, an embodiment of the Saw Cutting Guide device 100 of the present invention is depicted. The device 100 comprises a main base plate 10 having a top side 11 and an underside 13, an adjoining guide track 20 configured on the top side 11 for receiving and guiding a powered hand tool 60 and an alignment fence 40 pivotally mounted to the underside of the device 100 for selectively aligning the work piece in relation to the guide track 20. The device 100 may also include a mechanism for selectively securing or clamping the alignment fence 20 to the main base plate 10. In addition, the device 100 may also include a mechanism for selectively clamping the alignment fence 20 to a workpiece. While a preferred embodiment of the present invention is constructed primarily out of ¼″ metal plate and angle, it is understood that the Saw Cutting Guide of the present invention can be manufactured out of any suitably sturdy and rigid material including ferrous and non-ferrous materials, high-strength plastics, ceramics, wood, or any combination thereof.

Depending upon the material to be cut, the powered hand tool 60 may be any suitably equipped circular power saw, router, reciprocating sabre saw, or the like having a base plate or shoe dimensioned to slidably engage the guide elements 23 of the guide track 20. As depicted in the Figures, in a preferred embodiment the powered hand tool 60 is an electric-powered circular saw having a metal cutting blade, preferably featuring cold saw metal-cutting technology (e.g., the Metal Devil® brand circular saw by the M.K. Morse Company).

As depicted in the preferred embodiment of the Saw Cutting Guide device 100 shown in the Figures, the main base plate 10 comprises a planar surface having a curved front edge 16 and an opposing straight edge 17 abutting a supporting surface 22 of the guide track 20. While the main base plate 10 and the supporting surface 22 of the guide track 20 may be described as two distinct components, it is understood that the main base plate 10 and the supporting surface 22 of the guide track 20 may be constructed as a single unitized part or unit. For example, in a preferred embodiment the main base plate 10 and the supporting surface 22 of the guide track 20 is constructed as a single unitized part or unit; in which case the abutting straight edge 17 of the main base plate 10 and the complementary abutting edge 21 of the supporting surface 22 of the guide track 20 is only an imaginary line. Likewise, in an alternate embodiment, the main base plate 10 and the supporting surface 22 of the guide track 20 are constructed as two separate components, which are fixably joined together (e.g., by welding) along the complementary abutting edges 17, 21 to form a cohesive unit. In both embodiments, the supporting surface 22 is effectively a planar extension of the main base plate 10. Thus, the underside of the main base plate typically includes both the underside 13 of the main base plate 10 (proper) as well as the underside 22a of the supporting surface. Conversely, in yet another embodiment, the main base plate 10 and the supporting surface 22 of the guide track 20 is constructed as two separate components, which are then selectively joined (e.g., sliding dovetail joint or the like) along the complementary abutting edges 17, 21 so that the relative position of the supporting surface 22 of the guide track 20 along the abutting edge 17 of the main base plate 10 may be adjusted.

The underside of the device 100, that is the bottom surface 13 of the main base plate 10 along with the bottom surface 22a of the supporting surface 22 of the guide track 20, serves as a sturdy base upon which the device 100 may be placed on top of the workpiece. This is particularly advantageous when working with large, heavy workpieces like the steel I-beam depicted in the Figures. Moreover, the configuration of the device 100 in relation to the workpiece inherently shields an operator from debris created by the cutting action of the powered hand tool 60 thereby greatly enhancing operator safety.

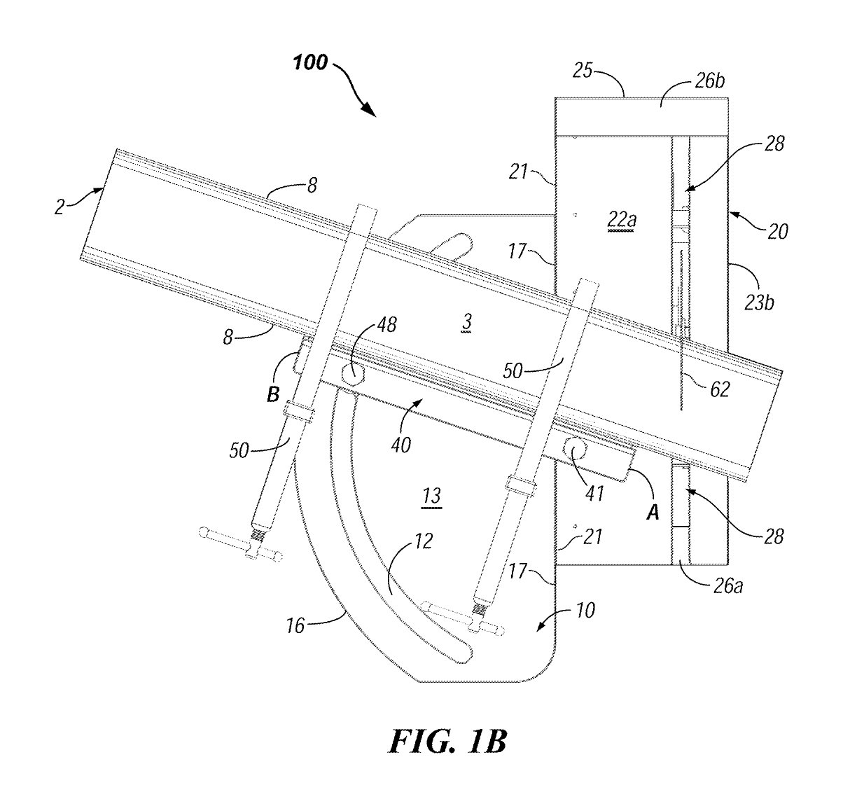

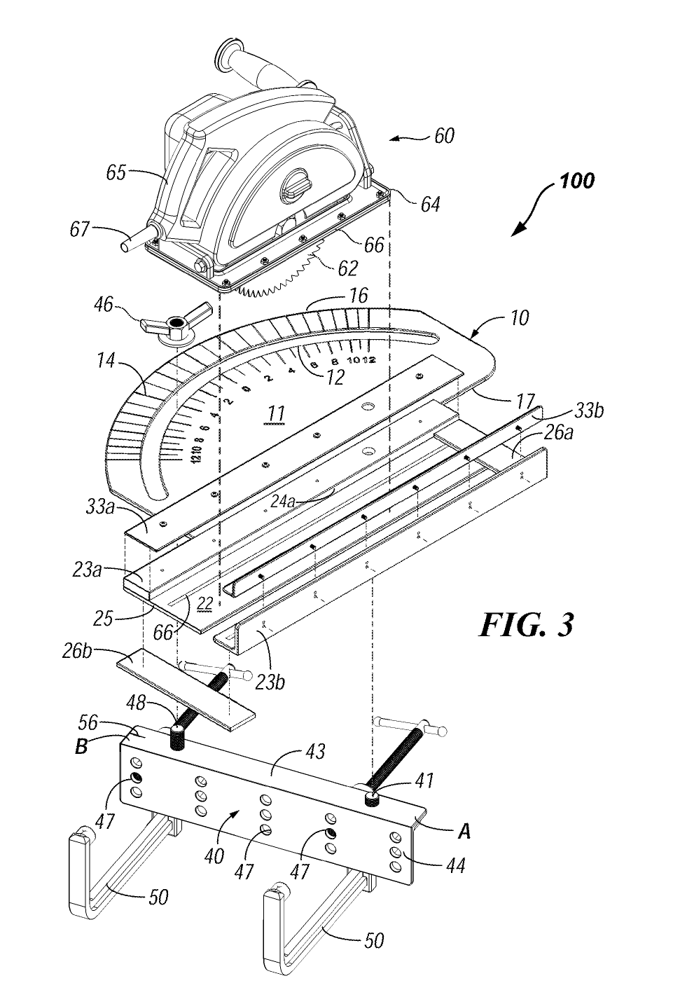

The Saw Cutting Guide device 100 of the present invention includes an alignment fence 40, which is pivotally mounted to the underside of the device 100, for selectively aligning the work piece in relation to the guide track 20. For example, as shown in FIGS. 1-4, the alignment fence 40 includes a horizontal face 43, which interfaces with the underside 13 of the main base plate 10; and a vertical face 44, which extends away from the horizontal face 43 and, consequently, the underside 13 of the main base plate 10. Preferably, the horizontal face 43 and the vertical face 44 are configured at a 90° angle from one another. The alignment fence 40 includes one end A, which is pivotally attached to the underside of the device 100 and a distal end B, which may be selectively positioned to align the workpiece in relation to the guide track 20.

For example, as depicted in the Figures, a bolt 41, extending through the horizontal face 43 of the alignment fence 40 and affixed to the underside 22a of the supporting surface 22, pivotally attaches the alignment fence 40 to the underside of the device 100. Alternatively, the pivot point can adjusted, such as by affixing the bolt 41 to the underside 13 of the main base plate 10. Regardless of the placement of the pivot point, the distal end B of the alignment fence 40 is able to rotate around the pivot point.

The alignment fence 40 may also include a clamping mechanism 50 for selectively holding the workpiece securely against the vertical face 44 of the alignment fence 40. For example, as shown in the Figures, in a preferred embodiment the clamping mechanism 50 comprises one or more F-style clamps. Preferably, the clamping mechanism 50 is permanently affixed to the alignment fence 40. Alternatively, the clamping mechanism 50 is detachable from the alignment fence 40. For example, the vertical face 44 of the alignment fence 40 may include one or more apertures or holes 47 appropriately sized for accepting standard pipe clamps. The holes 47 may be configured at different levels to handle a variety of differently sized workpieces.

The distal end B of the alignment fence 40 may further include a locking mechanism 45 for selectively securing or fixing the position of the alignment fence 40 relative to the main base plate 10. For example, in a preferred embodiment the main base plate 10 includes an arcuate slot 12 formed therein, which allows a threaded bolt 48 extending through the horizontal face 43 of the distal end B of the alignment fence 40 to extend from the underside 13 to the top side 11 of the main base plate 10. A washer and threaded wing nut or knob 46 threadably coupled to the bolt 48 is used to selectively secure or clamp the horizontal face 43 of the alignment fence 40 to the main base plate 10.

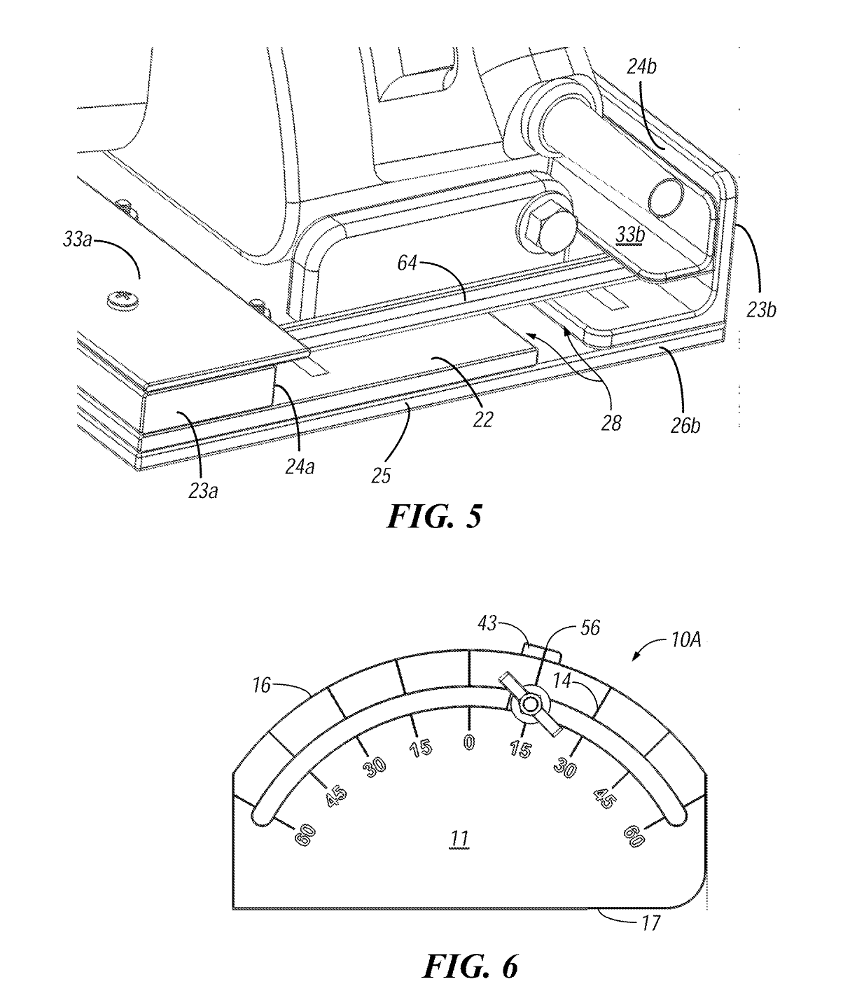

The top side 11 of the main base plate 10 may include indicia or reference marks 14 for assisting in setting the alignment of the alignment fence 40. For example, as depicted in the embodiment shown in FIGS. 1-3, the indicia or reference marks 14 denote standard pitch angles. In another embodiment, as depicted in FIG. 6, the top side 11 of the alternate main base plate 10A includes indicia or reference marks 14 denoted in standard arc degrees. Regardless of the indicia denoted, by aligning a cursor mark 56 on the alignment fence 40 with a specific reference mark the operator can rapidly and accurately set the angle of cut into the device.

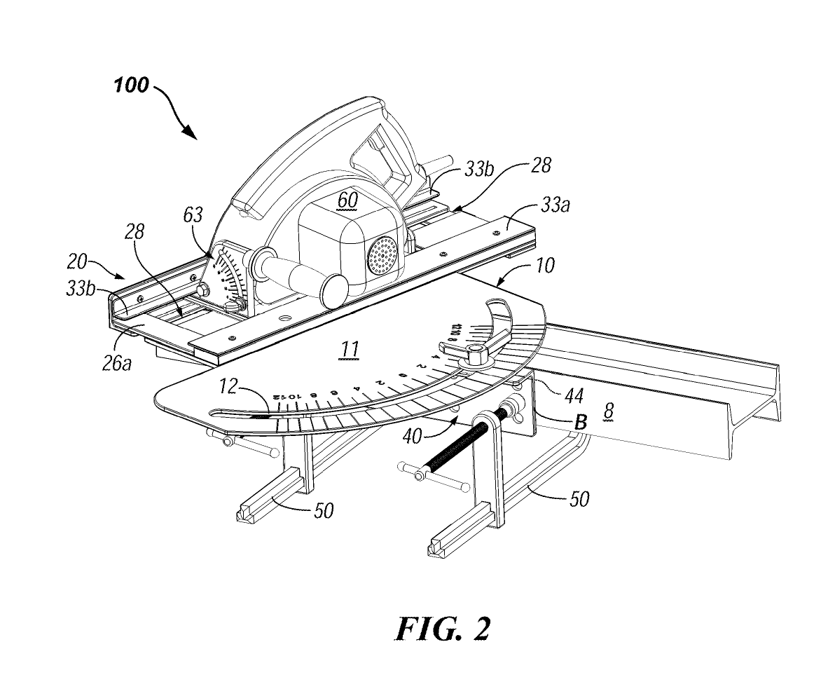

The guide track 20 comprises a supporting surface 22 having two guide elements 23, which are arranged in a substantially parallel configuration that enables the guide plate or shoe 64 of the powered hand tool 60 to be slidably engaged or captured therebetween. Preferably, the supporting surface 22 is a planar extension of the main base plate 10. A guide element 23 may simply comprise a planar rectangular bar attached to the guide track 20, wherein planar bar includes a straight lateral edge 24a for slidably engaging the powered hand tool 60. For example, as depicted in FIGS. 1A and 3, the left guide element 23a comprises a planar bar fixably attached to the supporting surface 22. The left guide element 23a includes a straight, planar lateral edge 24a for slidably engaging one of two opposing edges 66 of the rectangular guide plate or shoe 64 of the powered hand tool 60. The height or thickness of the lateral edge 24a is preferably more than that of the guide plate or shoe 64 of the powered hand tool 60.

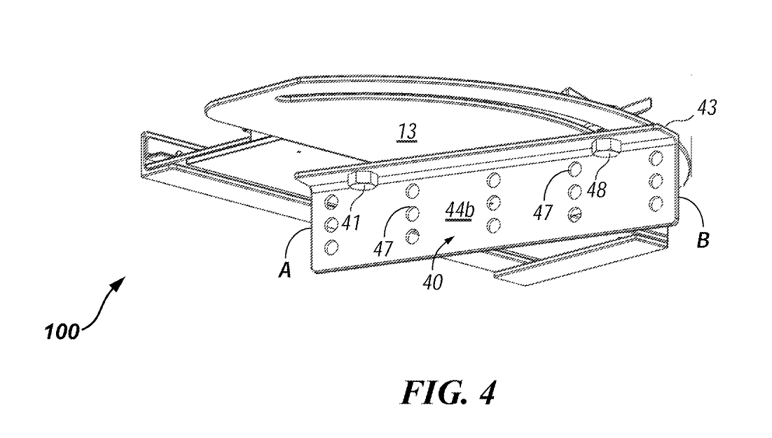

Guide element 23 may also comprise a length of angled material (e.g., angle iron or steel) having two planar surfaces configured at a 90° angle. For example, as depicted in FIGS. 1A, 3 and 5, the right guide element 23b comprises a length of angled material (e.g., angle iron or steel) having two planar surfaces configured at a 90° angle. The horizontal surface of the right guide element 23b is aligned with the planar surface of the supporting surface 22 while the vertical surface includes a straight, planar lateral edge 24b for slidably engaging the respective edge 66 of the guide plate or shoe 64 of the powered hand tool 60. Thus, the lateral edge 24b of the right guide element 23b is aligned in a substantially parallel configuration with the lateral edge 24a of the left guide element 23a.

The guide track 20 further includes a slot 28 formed in the supporting surface 22 between the two guide elements 23. The slot 28 allows the cutting edge 62 of the powered hand tool 60 to protrude or extend through the supporting surface 22 as the powered hand tool 60 advances within the guide track 20 to cut the workpiece 2 positioned underneath the device 100. The slot 28 is substantially aligned in parallel with the two guide elements 23.

The lateral position of the slot 28 between the two guide elements 23 is determined by the configuration of the guide plate 64 and cutting edge of powered hand tool 60. For example, the powered hand tool 60 depicted in FIG. 1A is a right-handed circular saw (i.e., a circular saw having its cutting blade 62 configured on the right-hand side of the tool and guide shoe). In contrast, a left-handed circular saw (e.g., a worm-drive circular saw) typically has its cutting blade configured on the left-hand side of the tool and guide shoe. Other powered hand tools, such as routers and reciprocating sabre saws, typically have their cutting edge configured at or near the center of the tool and guide shoe.

The lateral width of the slot 28 is at least as wide as the lateral width of the cutting edge of the powered hand tool 60. However, as depicted in the Figures, in preferred embodiments of the present invention the lateral width of the slot 28 is sufficiently wide to allow the powered hand tool 60 to tilt the cutting blade 62 laterally without impacting the edges of the slot 28. For example, by utilizing the tilting mechanism 63 on the powered hand tool 60 the blade 62 is tilted laterally, thereby adjusting the cut angle so that the blade 62 protrudes through the supporting surface at an acute or obtuse angle. By adjusting the cut angle of the blade 62 along with the angle of the alignment fence 40, the Saw Cutting Guide device 100 of the present invention enables an operator to safely and accurately cut compound mitered angles in a workpiece.

The guide track 20 also includes a cross-member 26a configured between the two guide elements 23 that limits the forward travel of the powered hand tool 60 in the guide track 20. The guide track 20 may also include an additional cross-member 26b between the two guide elements 23 at the rear 25 of the guide track 20 that limits the rearward travel of the powered hand tool 60 in the guide track 20 protecting the operator from kick back.

The guide track 20 may also include retainer devices 33 configured on top of one or both of the guide elements 23. The retainer devices 33 serve to restrain the powered hand tool 60 from lifting up vertically from the supporting surface 22 while the powered hand tool 60 travels within the guide track 20. For example, as shown in FIG. 1A, in one embodiment the retainer device 33a is a plate attached to the top of the guide element 23a. The plate is designed to extend over the lateral edge 24a of the guide element 23a preventing the guide plate 64 of the powered hand tool 60 from lifting up vertically when slidably engaged between the guide elements 23. In another embodiment, the retainer device 33b is a length of angled material attached to the lateral edge 24b (i.e., vertical surface of the right guide element 23b) that likewise prevents the guide plate 64 of the powered hand tool 60 from lifting up vertically when slidably engaged between the guide elements 23.

In another embodiment, the guide track 20 of the present invention may include a standardized sliding guide plate 64 permanently configured within the guide track 20. In such an embodiment, the guide plate 64 is adapted to interface with a wide variety of powered hand tools. That is, instead of designing the guide track 20 to fit a specific powered hand tool, a standardized sliding guide plate 64, which is slidably captured between the two guide elements 23, permits a wide variety of powered hand tools to be used with the same guide track 20.

The guide track 20 may also include friction reducing mechanisms for improving the ease with which an operator moves a powered hand tool 60 in the guide track 20. For example, the supporting surface 22 may include strips 66 of friction reducing materials such as ultra high molecular weight (UHMW) polyethylene or the like. Likewise, the lateral edges 24 of the guide elements 23 may also comprise UHMW polyethylene surfaces.

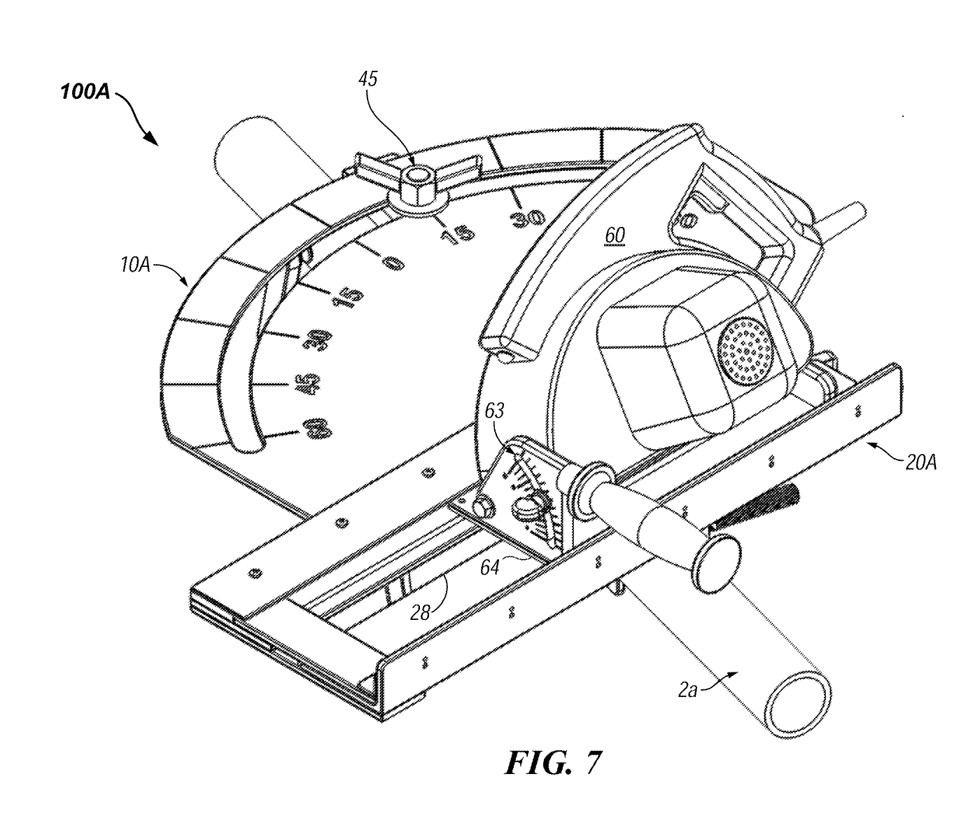

The Saw Cutting Guide device of the present invention includes embodiments configured as either right or left hand variants. For example, the embodiment of the device 100 shown in FIGS. 1-4 depicts a “right hand” variant, which, when viewed from the rear 25 of the guide track 20, has the guide track 20 configured to the right of the main base plate 10. Alternatively, the embodiment of the device 100A shown in FIG. 7 depicts a “left hand” variant, which, when viewed from the rear 25 of the guide track 20, has the guide track 20A configured to the left of the main base plate 10.

The Saw Cutting Guide device of the present invention enables an operator to safely and accurately cut miter cuts in workpieces. For example, with reference to FIG. 1A the operator places the device 100 on top of the workpiece (e.g., flange edge 6 of I-beam 2) with the vertical face 44 of the alignment fence 40 aligned along a reference surface (e.g., flange surface 8 of the I-beam 2). The operator then adjusts the alignment of the main base plate 10 in relation to the alignment fence 40 in order to position the guide track 20 at a desired angle of cross-cut. For example, the operator aligns the cursor mark 56 on the alignment fence 40 with a specific reference mark 14 on the top side of the main base plate 10. The operator then slidably engages the guide plate or shoe 64 of the powered hand tool 60 between the two guide elements 23 and pushes the powered hand tool 60 forward in the guide track 20 while energized, so that the blade 62 of the powered hand tool 60 extends through the slot 28 cutting the workpiece at the desired angle of cross-cut. Should the operator desire to create a compound bevel, the operator tilts the blade 62 laterally using tilting mechanism 63 attached to the guide plate or shoe 64 prior to initiating the cutting action.

The operator may also selectively secure or fix the position of the alignment fence 40 relative to the main base plate 10 by utilizing a locking mechanism which clamps the horizontal face 43 of the alignment fence 40 to the main base plate 10. In addition, the operator may also use clamping mechanisms 50 to selectively secure the reference surface against the vertical face 44 of the alignment fence 40.

It will now be evident to those skilled in the art that there has been described herein an improved saw cutting guide. Although the invention hereof has been described by way of a preferred embodiment, it will be evident that other adaptations and modifications can be employed without departing from the spirit and scope thereof. For example, the saw cutting guide device of the present invention would also be suitable for use with cutting and forming large wooden timbers. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A portable cutting guide for guiding a powered hand tool, comprising:
a main base plate having a top side and an underside;
a guide track, configured on the top side of said main base plate, said guide track including two guide elements configured in parallel, each of said guide elements having a planar lateral edge for slidably engaging therebetween a guide plate of said powered hand tool, wherein said guide track includes slot formed in said main base plate between said two guide element that enables a cutting edge of said powered hand tool to extend through the main base plate; and
an alignment fence, pivotally mounted to the underside of the main base plate, for selectively aligning a work piece in relation to said guide track.

2. The portable cutting guide of claim 1, further comprising a first cross-member configured between the two guide elements that limits the forward travel of the powered hand tool in the guide track.

3. The portable cutting guide of claim 2, further comprising a second cross- member configured between the two guide elements that limits the rearward travel of the powered hand tool slidably engaged in the guide track.

4. The portable cutting guide of claim 1, further comprising a locking mechanism for selectively securing the position of the alignment fence relative to the main base plate.

5. The portable cutting guide of claim 4, wherein said locking mechanism comprises a threaded bolt, connected to a distal end of said alignment fence and extending through an arcuate slot formed in said main base plate, which is threadably coupled to a knob, which selectively clamps the alignment fence to the main base plate.

6. The portable cutting guide of claim 1, wherein said alignment fence includes a horizontal face, which interfaces the underside of the main base plate, and a vertical face, which extends away from the horizontal face.

7. The portable cutting guide of claim 6, further comprising a clamping mechanism for selectively holding the workpiece securely against the vertical face of said alignment fence.

8. The portable cutting guide of claim 7, wherein said clamping mechanism comprises an F-style clamp.

9. The portable cutting guide of claim 8, wherein said F-style clamp is fixably attached to the vertical face of said alignment fence.

10. The portable cutting guide of claim 7, wherein said clamping mechanism comprises a pipe clamp mechanism.

11. The portable cutting guide of claim 10, wherein said vertical face of said alignment fence comprises at least one hole formed therein that is dimensioned for accepting a pipe clamp therethrough.

12. The portable cutting guide of claim 1 wherein said guide track further includes a retainer device configured on top of at least one guide element.

13. The portable cutting guide of claim 12, wherein said retainer device comprises a plate extending over the planar lateral edge of said at least one guide element.

14. The portable cutting guide of claim 12, wherein said retainer device comprises a length of angled material attached to the planar lateral edge of said at least one guide element.

15. The portable cutting guide of claim 1, wherein the top side of the main base plate further includes indicia, which indicate the angular position of the alignment fence relative to the guide track.

16. The portable cutting guide of claim 15, wherein the alignment fence includes a cursor for aligning with indicia.

17. The portable cutting guide of claim 15, wherein the indicia denote pitch angles.

18. The portable cutting guide of claim 15, wherein the indicia denote standard arc degree increments.

19. The portable cutting guide of claim 1, wherein the powered hand tool comprises an electric powered circular saw, router, or reciprocating sabre saw.

20. The portable cutting guide of claim 1, wherein the powered hand tool comprises an electric powered circular saw having a metal cutting blade featuring cold saw metal-cutting technology.

21. A method for cutting a metal workpiece with a metal-cutting electric circular saw comprising:
placing a portable cutting guide on top of said workpiece, said portable cutting guide comprising
a main base plate having a top side and an underside;
a guide track, configured on the top side of said main base plate, said guide track including two guide elements configured in parallel, each of said guide elements having a planar lateral edge for slidably engaging therebetween a guide plate of said metal-cutting electric circular saw, wherein said guide track includes slot formed in said main base plate between said two guide element that enables a cutting edge of said metal-cutting electric circular saw to extend through the main base plate; and
an alignment fence, pivotally mounted to the underside of the main base plate, for selectively aligning an metal workpiece in relation to said guide track; and
aligning a reference surface of said metal workpiece with said alignment fence;
adjusting the alignment of the main base plate in relation to the alignment fence in order to position the guide track at a desire angle of cross-cut;
engaging the guide plate of said metal-cutting electric circular saw in said guide track;
energizing said metal-cutting electric circular saw; and
advancing said metal-cutting electric circular saw forward in said guide track cutting said metal workpiece.

22. The method for cutting a metal workpiece of claim 21, further comprising selectively securing the alignment of the alignment fence relative to the main base plate with a locking mechanism.

23. The method for cutting a metal workpiece of claim 21, further comprising clamping the metal workpiece securely against a vertical face of said alignment fence prior to energizing said metal-cutting electric circular saw.
